(19) United States
(12) Patent Application Publication
(10) Pub. No.: US 2026/0306355 A1
(43) Pub. Date: Oct. 8, 2026

(54) HAND HELD COOLING DEVICE

(71) Applicant: DD Karma LLC d/b/a Dermaflash, Chicago, IL (US)

(72) Inventor: Dara Levy, Highland Park, IL (US)

(73) Assignee: DD Karma LLC d/b/a Dermaflash, Chicago, IL (US)

(21) Appl. No.: 19/639,742

(22) Filed: Apr. 6, 2026

Related U.S. Application Data
(60) Provisional application No. 63/784,552, filed on Apr. 7, 2025.

(51) Int. Cl. A61H 23/02

(52) U.S. Cl. CPC A61H 23/02; A61H 2201/0153; A61H 2201/0214; A61H 2201/0264; A61H 2201/0285

(57) ABSTRACT

Aspects disclosed herein relate to skin treatment devices and associated methods of use. In some embodiments, a skin treatment device disclosed herein may be configured as a cooling device having an applicator arranged to contact a user's skin. In some embodiments, the cooling device may also include a thermoelectric element arranged in thermal contact with the applicator to adjust a surface temperature of the applicator and a vibrator arranged to vibrate the applicator.

### CROSS-REFERENCE TO RELATED APPLICATIONS

This application claims the benefit under 35 U.S.C § 119(e) to U.S. Provisional Application Ser. No. 63/784,552, filed on Apr. 7, 2025, which is hereby incorporated by reference in its entirety.

### FIELD

Disclosed embodiments are directed to skin treatment devices and associated methods of use. More particularly, disclosed embodiments are related to hand held cooling devices configured for use in skin treatment.

### BACKGROUND

Various skin treatment devices have been employed to reduce puffiness, improve elasticity of the skin, and enhance skin radiance, among other skin treatment benefits. For example, some users place facial massage rollers in a freezer to lower the surface temperature of the rollers. The cooled rollers are then used to massage the user's face to drain lymphatic fluid and reduce inflammation.

### SUMMARY

According to some embodiments, a skin treatment device is provided. The skin treatment device may include an applicator having an external surface configured to contact skin of a user. The device may also include a vibrator configured to vibrate the applicator when actuated by the user, and a thermoelectric element positioned adjacent to the vibrator. In some embodiments, the thermoelectric element may be arranged to be in thermal contact with the applicator such that thermal energy transmitted from the thermoelectric element is configured to adjust a temperature of the external surface to provide thermal sensations to the skin of the user when the applicator contacts the skin of the user.

According to some embodiments, a method of operating a skin treatment device is provided. The method may include activating a vibrator to vibrate an applicator having an external surface arranged to contact skin of a user. The method may also include activating a thermoelectric element in thermal contact with the applicator such that the thermoelectric element transmits thermal energy to the applicator to adjust a temperature of the external surface. In some embodiments, the thermoelectric element may be positioned adjacent to the vibrator. The method may further include contacting the external surface of the applicator against the skin of the user such that the external surface provides thermal sensations to the skin of the user using the thermal energy transmitted by the thermoelectric element.

According to some embodiments, a skin treatment device is provided. The skin treatment device may include a body having an interior volume, a proximal portion, and a distal portion opposite the proximal portion. The device may also include an applicator having an external surface configured to contact skin of a user. In some embodiments, the applicator may be coupled to the body such that the applicator is closer to the distal portion of the body than the proximal portion of the body. The device may also include a thermoelectric element arranged to be in thermal contact with the applicator such that thermal energy transmitted from the thermoelectric element is configured to adjust a temperature of the external surface to provide thermal sensations to the skin of the user when the applicator contacts the skin of the user. The device may also include at least one inlet opening positioned on the body configured to direct airflow into the interior volume, and at least one outlet opening positioned on the body and configured to direct the airflow out of the interior volume. In some embodiments, the at least one inlet opening and the at least one outlet opening may be positioned on the distal portion of the body.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

Non-limiting embodiments that incorporate one or more aspects of the invention will be described by way of example with reference to the accompanying figures, which are not necessarily drawn to scale. For purposes of clarity, not every component may be labeled in every figure, nor is every component of each embodiment of the invention shown where illustration is not necessary to allow those of ordinary skill in the art to understand the invention. In the figures:

FIG. 1 is a front view of a skin treatment device, according to some embodiments;

FIG. 2 is an enlarged perspective view of the skin treatment device of FIG. 1 with a housing of the device removed and the applicator shown in phantom for clarity;

FIG. 3 is an enlarged side view of the skin treatment device of FIG. 1 with the device body shown in phantom for clarity;

FIG. 4 is a perspective sectional view of the skin treatment device of FIG. 1 taken along lines 4A-4A, according to some embodiments;

FIG. 5 is a front view of the skin treatment device of FIG. 1 shown in combination with a removable cap and a charging base, according to some embodiments; and

FIG. 6 is a chart depicting temperature data results obtained using some of the embodiments disclosed herein.

### DETAILED DESCRIPTION

Various skin treatment devices have been employed to reduce puffiness, improve elasticity of the skin, and enhance skin radiance, among other skin treatment benefits. For example, some users place facial massage rollers in a freezer to lower the surface temperature of the rollers. The cooled rollers are then used to massage the user's face to drain lymphatic fluid and reduce inflammation.

The inventor(s) have appreciated that existing cooling devices, e.g., facial massage rollers, typically are dependent on use of a freezer to reach a desired surface temperature. Such cooling devices may have inconsistent surface temperatures and may be time consuming to use. The inventor(s) have also found that such cooling devices may not reach a sufficiently cold temperature due to the surface temperature being dependent on the ambient freezer temperature. Accordingly, the inventor(s) have appreciated that it is desirable to provide a hand held skin treatment device that is capable of providing a desired degree of cooling to the user's skin on demand, e.g., by using a cooling system incorporated within the hand held device itself.

The inventor(s) have also recognized benefits associated with providing a vibrator in the hand held device, e.g., in combination with the cooling system referenced above. The inventor(s) have appreciated that providing both a cooling system and a vibrator in a skin treatment device may provide several benefits including reduced inflammation and improved lymphatic drainage for the user.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

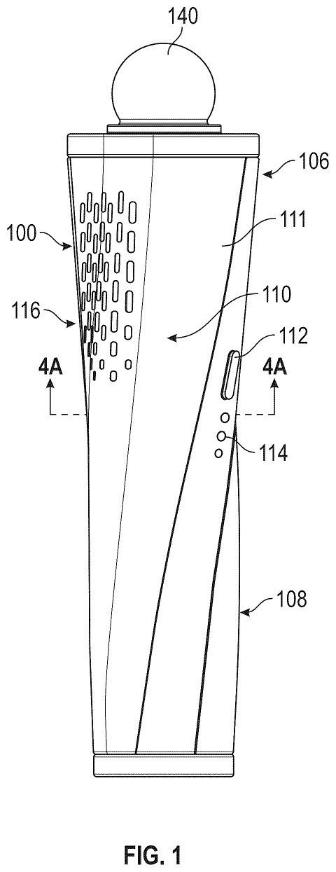

FIG. 1 is a front view of a skin treatment device 100. The device 100 includes a device body 110 and an applicator 140 positioned near a distal portion 106 of the body 110. That is, the applicator 140 may be coupled to the body 110 such that the applicator is closer to a distal portion 106 of the body than a proximal portion 108 of the body opposite the distal portion 106. As disclosed herein, an external surface of the applicator 140 may contact the skin of a user to provide thermal sensations (e.g., cooling and/or heating) and/or to massage the user's skin (e.g., via vibrations) to reduce inflammation and improve lymphatic drainage.

The device body 110 includes a button 112. The button 112 may be used to activate a cooling cycle and/or a vibration cycle for the device. In some embodiments, such cycles may be automatically activated for a predetermined time period when the button 112 is pressed. For example, a cooling and/or vibration cycle may be activated for a 6 minute period before automatically shutting off. In some embodiments, the user may be able to manually control the surface temperature of the applicator and/or the rate of vibration during the cycle. For example, the user may hold down the button 112 for approximately 2 seconds to initiate the cycle or to terminate the cycle thereafter. While the cycle is active, the user may quickly press the button to increase or decrease a rate of cooling and/or vibration applied to the applicator 140.

While such an example is disclosed above, the cooling and/or vibration cycle may be configured in any suitable fashion as the disclosure is not so limited. In some embodiments, a cycle may last a predetermined time period of greater than or equal to 10 seconds, 20 seconds, 30 seconds, 40 seconds, 50 seconds, 60 seconds, 90 seconds, 2 minutes, 3 minutes 4 minutes, 5 minutes, 6 minutes, 7 minutes, 8 minutes, 9 minutes, or greater. Likewise, in some embodiments, a cycle may last a predetermined time period of less than or equal to 10 minutes, 9 minutes, 8 minutes, 7 minutes, 6 minutes, 5 minutes, 4 minutes, 3 minutes, 2 minutes, 90 seconds, or less.

The body 110 also includes one or more indicators 114 (e.g., LED lights). The indicators 114 may be used to indicate a variety of device functions including, but not limited to: indicating a battery level of the device, indicating whether the device is actively charging, indicating whether a cooling cycle and/or a vibration cycle is active, indicating a degree of temperature and/or a rate of vibration for the active cycle (e.g., if more indicators are illuminated then the degree of cooling and/or rate of vibration may be higher), or any other suitable function as the disclosure is not so limited.

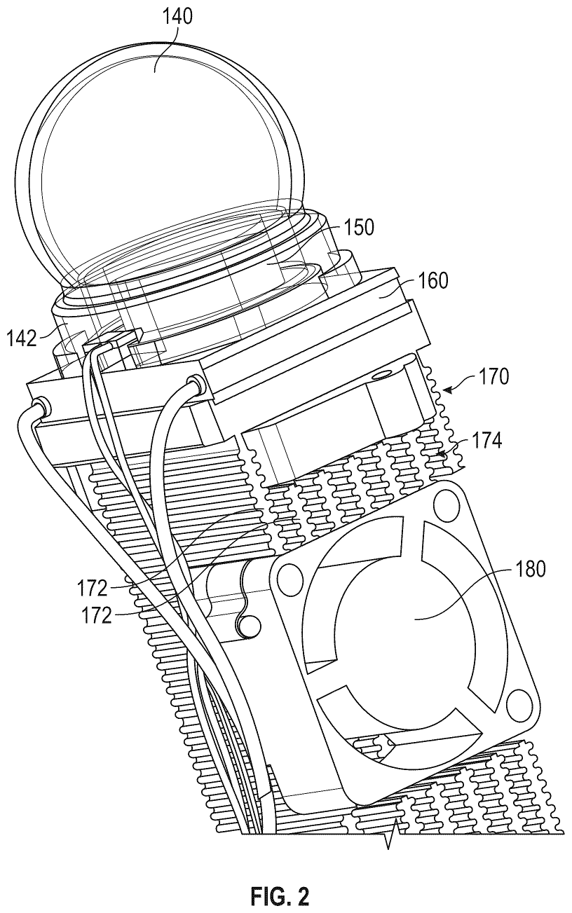

FIG. 2 is an enlarged perspective view of the skin treatment device 100 with the housing 111 of the device body 110 removed and the applicator 140 shown in phantom for clarity. As shown in FIG. 2, a vibrator 150 (e.g. a motor, such as a sonic vibration motor or other vibration motor), may be received within an interior volume of a base 142 of the applicator 140 such that the vibrator may vibrate the applicator 140 when activated. The vibrator 150 may also be positioned adjacent a thermoelectric element 160 (such as a Peltier device), with the cold side of the thermoelectric element arranged to face the vibrator. The thermoelectric element may also be arranged in thermal contact with the applicator such that activation of the thermoelectric element adjusts a temperature of the applicator's external surface. In this fashion, the thermoelectric element may be able to provide cooling to both the vibrator and the applicator simultaneously. The inventor(s) have appreciated that this positional arrangement may prolong the operational life of the vibrator by limiting overheating. In some embodiments, the thermoelectric element may be arranged as an elongate Peltier thermoelectric cooling pad, as shown in FIG. 2. However, the thermoelectric element may be of any suitable shape and/or size to provide cooling to the applicator 140 as the disclosure is not so limited. In some embodiments, the applicator 140 may be fully hollow, which may increase the rate at which the thermoelectric element is able to adjust a surface temperature of the applicator. In other embodiments, however, the applicator 140 may only be partially hollow, e.g., only the base portion which receives the vibrator 150 may be hollow while the remainder of the applicator 140 (e.g., the “dome” portion) is solid.

In addition, although the thermoelectric element 160 in FIG. 2 is shown with the cooling side arranged to face the applicator 140 and the vibrator 150, in some embodiments, the thermoelectric element may be flipped around. That is, the heating side of the thermoelectric element 160 may be arranged in contact with the applicator 140 to increase a surface temperature of the applicator. The user may then contact the applicator to the skin to provide heated thermal sensations.

The applicator 140 may be constructed at least partially in a spherical or domed shape as shown in FIGS. 1-2 to improve the ability of the applicator to glide and massage a desired area of the user's skin. However, the applicator may be formed in any suitable shape such as a cylinder, rectangular prism, trapezoidal prism, or any other suitable shape as the disclosure is not so limited.

The applicator 140 may also be of any suitable size for use in contacting the user's skin. For example, a spherical-shaped or dome-shaped applicator may have a diameter of greater than or equal to 5 mm, 10 mm, 15 mm, 16 mm, 17 mm, 18 mm, 19 mm, 20 mm, 21 mm, 22 mm, 23 mm, 24 mm, 25 mm, 30 mm, or greater. Likewise, in some embodiments, the applicator may have a diameter of less than or equal to 35 mm, 30 mm, 25 mm, 24 mm, 23 mm, 22 mm, 21 mm, 20 mm, 19 mm, 18 mm, 17 mm, 16 mm, 15 mm, 10 mm, or lesser.

In some embodiments, the applicator 140 may be constructed out of copper (e.g., approximately 99% pure copper), which the inventor(s) have appreciated may be beneficial due to the high thermal conductivity of copper (e.g., approximately 400 W/mK at 25° C.). That is, the thermoelectric element 160 may be able to efficiently transfer thermal energy to the copper applicator 140 to adjust the surface temperature of the applicator 140. The inventor(s) have also appreciated that using pure copper for the applicator material is beneficial in that copper has natural antimicrobial properties which provide benefits when contacting the skin. In some embodiments, the applicator may be constructed out of other materials than copper or copper alloys such as silver, aluminum, gold, or metal alloys such as brass, or any other suitable material as the disclosure is not so limited.

In some embodiments, the applicator may be constructed to have a composite structure. That is, the applicator may be constructed out of two or more materials, which may be layered on one another. For example, the applicator may include a first aluminum alloy layer and a second copper layer positioned outwardly of the first layer. In some embodiments, the applicator may be plated with one or more materials. For example, the applicator may include an aluminum alloy layer, nickel plating layered on the aluminum alloy layer, and a copper layer disposed on the nickel plating such that the nickel plating is disposed between the aluminum alloy and copper layers. The inventors have appreciated that such a configuration may provide benefits including improved adhesion and bonding strength, mitigation of galvanic corrosion, and reduced coating porosity. While such examples are disclosed, any suitable materials may be layered in any suitable fashion as the disclosure is not so limited.

In some embodiments, the external surface of the applicator may be treated and/or coated. For example, a passivation treatment may be applied to the external surface of the applicator. The inventor(s) have appreciated that such a treatment may limit or prevent patina formation and promote faster copper ion release for more effective antimicrobial performance while also not substantially inhibiting the cooling performance of the applicator. For example, a Cuprous oxide layer on the applicator surface may have better antimicrobial properties and promote fastener copper ion release.

In some embodiments, the external surface of the applicator may be treated with an organic polymer coating, such as an electrophoretic paint which may serve as a protective layer and be resistant to oxidation. The coating may optionally be water-based. In some embodiments, the coating may include an anti-microbial additive such as silane quaternary ammonium salts, copper ion complexes, silver nanoparticles, or any other suitable additive as the disclosure is not so limited. In some embodiments, the coating may be constructed to be transparent. In some embodiments, the coating may be constructed to have cavities (e.g., micro-scale cavities and/or nano-scale cavities), and the cavities may be arranged to provide a semi-permeable or permeable membrane. The membrane may be configured to draw substances through the membrane of the coating (e.g., substances from the user's skin) into contact with an underlying material (e.g., a copper layer) through capillary action to improve anti-microbial performance.

In some embodiments, the organic polymer coating may space the one or more layers underlying the coating from the target site (e.g., the user's skin) during use. In addition or alternatively to including an organic polymer coating on the applicator, the underlying material may have anti-microbial properties or an anti-microbial coating such that the substances drawn through the membrane may be exposed to the anti-microbial surfaces.

In some embodiments, the vibrator may be shaped as a cylinder, as shown in FIG. 2. However, the disclosure is not so limited and the vibrator may instead be shaped as a rectangular prism, a sphere, a trapezoidal prism, or any other suitable shape.

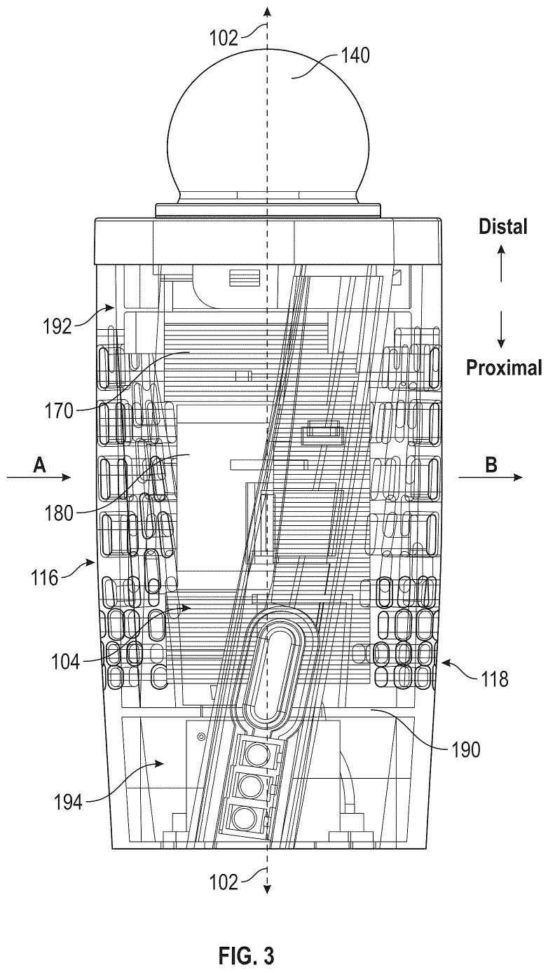

As shown in FIG. 2, the thermoelectric element 160 may be arranged with the cooling side facing the vibrator 150 and applicator 140 while the heating side faces a heat sink 170. In this fashion, the thermoelectric element may cool the vibrator and applicator while the heat is drawn into the heat sink 170. To facilitate heat exchange from the heat sink 170 to the surrounding environment, a fan 180 may be provided that is configured to flow air through the interior volume of the device body to cool the temperature of the heat sink, as will be discussed in more detail in reference to FIG. 3. In some embodiments, the fan 180 may be at least partially surrounded by the heat sink 170 as shown in FIG. 2. Such a configuration allows for the fan and heat sink to be contained within the device body 110 in a compact fashion. The heat sink 170 may be constructed out of copper to promote heat transfer from the thermoelectric element 160 to the heat sink due to copper's high thermal conductivity. The heat sink may also be arranged to have void space 174 between various ribbed fins 172 to allow airflow between the fins for cooling the heat sink, as discussed in reference to FIG. 3.

FIG. 3 is an enlarged side view of the skin treatment device 100 with the device body 110 shown in phantom for clarity. The body 110 includes a first set of holes 116 and a second set of holes 118. As disclosed herein, the first and second sets of holes may be configured as air inflow and air exhaust holes, respectively. That is, the first set of holes 116 may be configured to receive airflow in the direction of arrow “A” and the airflow may exit through the second set of holes 118 in the direction of arrow “B”. As used herein, “air inflow holes” and “air exhaust holes” may also be referred to as inlet openings and outlet openings, respectively. As will be appreciated, such airflow through an interior volume 104 of the device body 110 may cool the heat sink 170 positioned within the interior volume 104. More particularly, the heat sink 170 may be arranged in relation to the first and second sets of holes 116, 118 such that the air flowing through the holes flows along the void space 174 to cool the fins 172. Similarly, the fan 180 may be oriented relative to the holes 116, 118 such that the fan draws in the air through the first set of holes 116 and then urges the air to exit the second set of holes 118. For example, the fan 180 may be positioned adjacent to the first set of holes 116 to optimize air inflow, as shown in FIG. 3.

As shown in FIG. 3, the two sets of holes 116, 118 may be oriented on respective faces (e.g., opposing front and back surfaces) of the body 110. In some embodiments, the first and second sets of holes 116, 118 may be located at approximately the same height (i.e., the same height along the longitudinal axis of 102 of the device) on the opposing surfaces of the body 110, as shown in FIG. 3. In some embodiments, both sets of the holes 116, 118 may be positioned on a distal portion 106 of the body, as shown in FIG. 1 and FIG. 3. The holes 116, 118 may be oriented such that the airflow in the directions “A” and “B” is at an angle relative to the longitudinal axis 102 (e.g. transverse or other angle). The inventor(s) have appreciated that such a configuration may allow for the air to flow more efficiently through the interior volume 104 of the body 110 between the air inflow holes 116 and the air exhaust holes 118. That is, in embodiments where the holes 116, 118 are located at similar heights on opposing surfaces in a direction transverse to the longitudinal axis 102, airflow efficiency may be improved because the tendency of the flowing air to circulate in the interior volume 104 is reduced. In contrast, if the sets of holes were located at different heights, e.g., if the holes 116 were oriented vertically higher along longitudinal axis 102 relative to the holes 118, the air would have to flow in the direction of axis 102 to exit holes 118 which would increase circulation of the air within the interior volume. In addition, the inventor(s) have appreciated that by providing both sets of holes 116, 118 on the distal portion 106, the airflow pathway may be shorter than requiring the air to flow from a set of holes on the distal portion to a set of holes on the proximal portion, or vice versa.

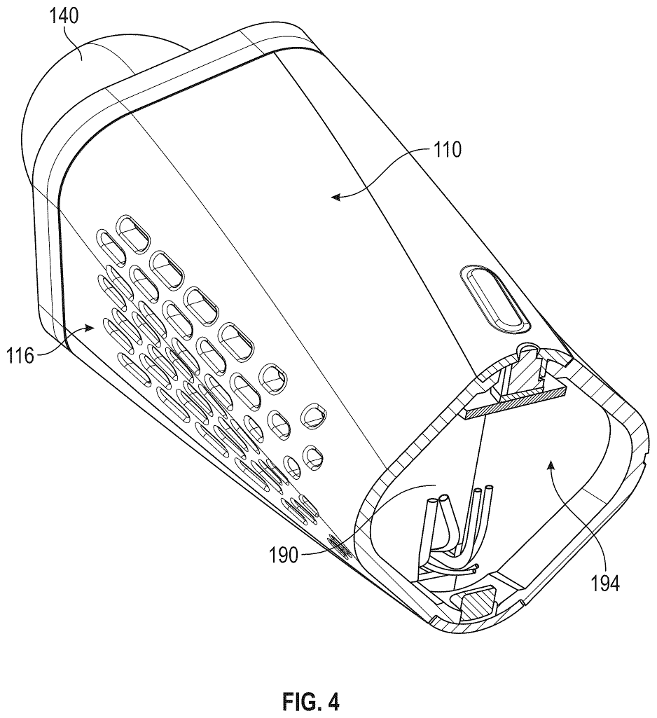

FIG. 4 is a perspective sectional view of the skin treatment device 100 of FIG. 1 taken along lines 4A-4A, according to some embodiments. As shown in FIG. 4, the device body 110 includes a partition wall 190 positioned between the proximal and distal portions of the device (also see FIG. 3) which separates an interior volume 104 of the device body into first and second compartments 192 and 194, respectively (see also FIG. 3). The first compartment 192 houses the heat sink 170 and the fan 180 whereas the second compartment 194 houses the battery storage and electronics (e.g., a controller and one or more processors). The inventor(s) have appreciated that the partition wall 190 may reduce air circulation within the interior volume 104 of the body to improve cooling of the heat sink. That is, with the inclusion of the partition wall 190, the air flowing through the device body is directed to flow out of the second set of holes 118 rather than circulating in the interior volume 104 of the device body closer to the battery storage. This configuration may improve the heat transfer between the heat sink and the surrounding environment by streamlining the direction of airflow.

As shown in FIG. 4, the holes 116, 118 may be formed in an elongate shape with a rounded edge oriented towards an exterior of the device body. That is, the edge of the holes 116 may be tapered inwards towards the interior volume 104 of the device body such that airflow is deflected off the rounded edge and inwards towards the interior volume. In some embodiments, the holes 116, 118 may be arranged in a staggered grid pattern, as shown in FIG. 4. The inventor(s) have appreciated that providing a staggered grid pattern of elongate holes may improve the airflow efficiency while also reducing the impact of the open space of the holes on the structural integrity of the device body. Accordingly, the size and positioning of the elongate holes may be selected according to the wall thickness of the device body to maximize airflow while maintaining the structural integrity of the body.

In some embodiments, the second set of holes 118 (i.e., the air exhaust holes) may have a greater volume of open space than the first set of holes 116 (i.e., the air inflow holes). That is, the second set of holes 118 may be of a greater number and/or size such that there is a greater volume of “open space” or “void space” through which air can exit the interior volume 104. The inventor(s) have appreciated that such a configuration may improve the efficiency of airflow through the interior volume by reducing the amount of air that circulates within the interior volume.

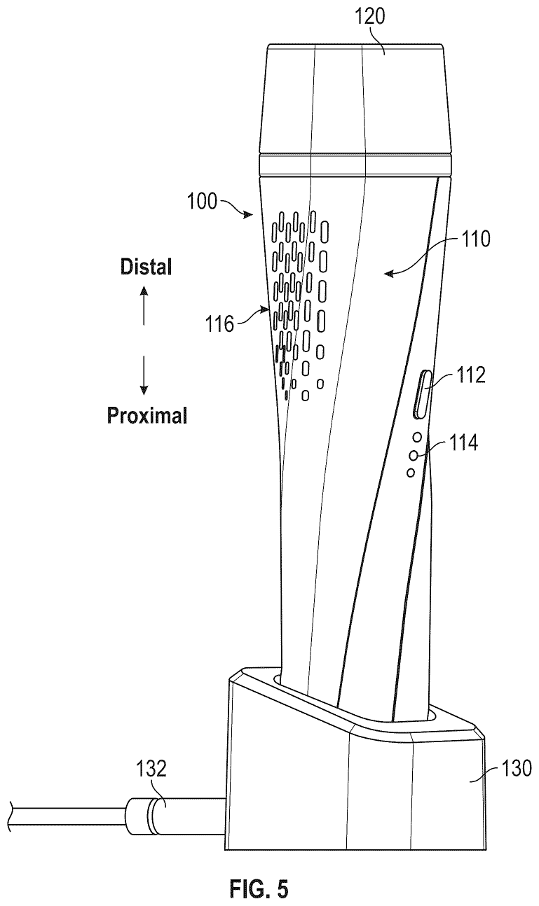

FIG. 5 is a front view of the skin treatment device 100 of FIG. 1 shown in combination with a removable cap 120 and a charging base 130, according to some embodiments. The removable cap 120 may be positioned over a distal end portion of the body 110, and the charging base 130 may be configured to receive a proximal end portion of the body 110. The cap 120 may removably cover the applicator 140. In some embodiments, the cap 120 may be magnetically engaged with the device body 110 but the disclosure is not so limited, and the cap may be otherwise removably engaged to the body 110 via a snap fit, an interference fit, or any other suitable fastening method.

The charging base 130 may be configured to engage a corresponding charging feature at the proximal end portion of the body 110. For example, the device body 110 may include a centralized female connector configured to engage with a centralized male connector located on the charging base 130. Such a centralized charging arrangement may allow for the device 100 to be inserted into the charging base 130 at any suitable angle of rotation while charging. The energy collected from charging may be stored in one or more batteries located in a lower compartment of the device body 110. The charging base 130 may be in electrical communication with a charging cord 132 for wall charging. The device body 110 may also include one or more separate charging ports (e.g., USB-C ports) for charging the device in a portable fashion independently of the charging base. As disclosed herein, the indicators 114 located on the body 110 may be arranged to indicate whether the device is actively charging, among other functions.

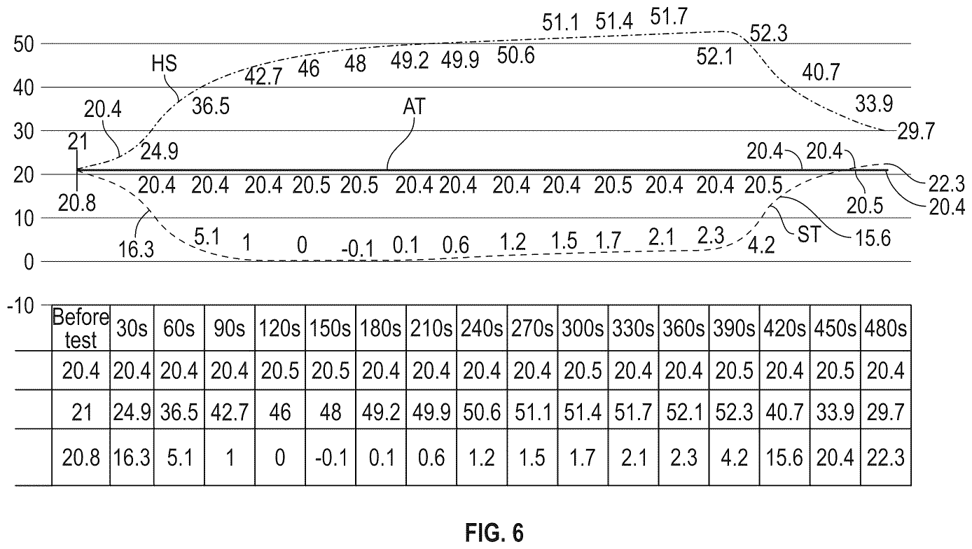

FIG. 6 is a chart depicting temperature data results obtained using the embodiments disclosed herein. In particular, the bottom line “ST” refers to a surface temperature of the applicator during a cooling cycle whereas the top line “HS” refers to a temperature of the heat sink during the cycle. The chart also shows the ambient temperature “AT” during the temperature data collection. As shown in FIG. 6, as the surface temperature ST of the applicator decreases, the temperature of the heat sink HS increases. Likewise, as the surface temperature ST of the applicator increases the temperature of the heat sink HS decreases. The chart also shows that the applicator surface temperature ST experiences three general stages of temperature fluctuation during a cooling cycle: a first “ramp down” period, a second “steady temperature” period, and a third “ramp up” period, with the second period being the predominant period in which the applicator contacts the user's skin. During the second period, the device may achieve an applicator surface temperature of between or equal to approximately 0° C. and 5° C. However, a portion of the temperature cycle may experience any suitable range of temperatures including between or equal to 0° C. and 20° C., 0° C. and 10° C., 0° C. and 5° C., 0° C. and 3° C., 0° C. and 1° C., or any other suitable range as the disclosure is not so limited.

In some embodiments, the treatment device may include a controller and one or more processors configured to actively control the thermoelectric element and the corresponding surface temperature of the applicator over the cooling cycle. That is, the controller may regulate the activation of the thermoelectric element based on the temperature of the applicator's surface, e.g., to achieve a desired range of surface temperatures. The controller may also perform other functions including generating a desired time period for keeping the thermoelectric element activated, activating the fan and/or operating the vibrator.

For purposes of this patent application and any patent issuing thereon, the indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

The use of “including,” “comprising,” “having,” “containing,” “involving,” and/or variations thereof herein, is meant to encompass the items listed thereafter and equivalents thereof as well as additional items.

The embodiments described herein may be embodied as a method. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A skin treatment device comprising:
an applicator having an external surface configured to contact skin of a user;
a vibrator configured to vibrate the applicator when actuated by the user; and
a thermoelectric element positioned adjacent to the vibrator, wherein the thermoelectric element is arranged to be in thermal contact with the applicator such that thermal energy transmitted from the thermoelectric element is configured to adjust a temperature of the external surface to provide thermal sensations to the skin of the user when the applicator contacts the skin of the user.

2. The skin treatment device of claim 1, further comprising one or more holes formed in a body of the device, wherein the one or more holes are configured to receive airflow through an interior volume of the device body.

3. The skin treatment device of claim 2, further comprising a fan positioned within the interior volume of the device body, wherein the fan is configured to direct the airflow through the one or more holes.

4. The skin treatment device of claim 2, wherein the one or more holes includes a first set of holes configured to direct the airflow into the interior volume, and a second set of holes configured to direct the airflow out of the interior volume.

5. The skin treatment device of claim 4, wherein the second set of holes have a greater volume of open space than the first set of holes.

6. The skin treatment device of claim 2, wherein the one or more holes are formed in an elongate shape with a rounded edge oriented towards an exterior of the device body.

7. The skin treatment device of claim 2, wherein the one or more holes include a plurality of holes arranged in a staggered grid pattern.

8. The skin treatment device of claim 1, further comprising a partition wall separating an interior volume of the device into first and second compartments.

9. The skin treatment device of claim 1, wherein the applicator is constructed in a spherical shape or a dome shape.

10. The skin treatment device of claim 1, wherein the applicator is constructed out of a copper material.

11. The skin treatment device of claim 1, wherein the vibrator is positioned within an interior volume of the applicator.

12. The skin treatment device of claim 1, further comprising a magnetic cap configured to removably cover the applicator.

13. The skin treatment device of claim 1, wherein the thermoelectric element is configured to adjust the temperature of the applicator external surface for a predetermined temperature cycle.

14. The skin treatment device of claim 13, wherein the temperature of the external surface of the applicator is between or equal to 0° C. and 10° C. for at least a portion of the temperature cycle.

15. The skin treatment device of claim 1, wherein the external surface of the applicator is treated with a passivation treatment.

16. The skin treatment device of claim 1, wherein a cooling side of the thermoelectric element is oriented towards the vibrator.

17. The skin treatment device of claim 16, wherein a heating side of the thermoelectric element is oriented towards a heat sink configured to receive thermal energy from the thermoelectric element.

18. A method of operating a skin treatment device, the method comprising:
activating a vibrator to vibrate an applicator having an external surface arranged to contact skin of a user;
activating a thermoelectric element in thermal contact with the applicator such that the thermoelectric element transmits thermal energy to the applicator to adjust a temperature of the external surface, wherein the thermoelectric element is positioned adjacent to the vibrator; and
contacting the external surface of the applicator against the skin of the user such that the external surface provides thermal sensations to the skin of the user using the thermal energy transmitted by the thermoelectric element.

19. The method of claim 18, further comprising directing airflow through an interior volume of a body of the device through one or more holes formed in the body.

20-34. (canceled)

35. A skin treatment device comprising:
a body having an interior volume, a proximal portion, and a distal portion opposite to the proximal portion;
an applicator having an external surface configured to contact skin of a user, the applicator being coupled to the body such that the applicator is closer to the distal portion of the body than the proximal portion of the body;
a thermoelectric element arranged to be in thermal contact with the applicator such that thermal energy transmitted from the thermoelectric element is configured to adjust a temperature of the external surface to provide thermal sensations to the skin of the user when the applicator contacts the skin of the user;
at least one inlet opening positioned on the body and being configured to direct airflow into the interior volume of the body; and
at least one outlet opening positioned on the body and being configured to direct the airflow out of the interior volume, wherein the at least one inlet opening and the at least one outlet opening are positioned on the distal portion of the body.

36-49. (canceled)
